(19) United States
(12) Patent Application Publication
(10) Pub. No.: US 2011/0130206 A1
(43) Pub. Date: Jun. 2, 2011

(54) Apparatus for supporting and decorating a window

(76) Inventor: Yi-Chiang Yang, Changhwa (TW)

(21) Appl. No.: 12/592,609

(22) Filed: Nov. 30, 2009

(51) Int. Cl. G06F 19/00; A63F 9/00

(52) U.S. Cl. 463/46; 273/448

(57) ABSTRACT

Disclosed is an apparatus for supporting and decorating a window. The apparatus includes a frame, a lamp and a lens assembly. The frame includes a middle slab formed between two lateral slabs. Each of the lateral slabs includes a window-receiving groove, a V-shaped groove and a lens-receiving groove. The depth of the window-receiving groove of each of the lateral slabs is at an angle from that of the window-receiving groove of the other lateral slab. The middle slab is in parallel to a plane in which valleys of the V-shaped grooves of the lateral slabs lie. The lamp includes illuminators supported on a board. The board includes two edges inserted in the V-shaped grooves. The lens assembly includes lenses each including at least two tongues each extending from a side and including a tip movably inserted in the lens-receiving groove of a related one of the lateral slabs.

### BACKGROUND OF INVENTION

1. Field of Invention

The present invention relates to a game machine and, more particularly, to a convenient apparatus for supporting and decorating a window of a game machine.

2. Related Prior Art

There are various kinds of game machines for entertaining players. A kind of game machines includes a booth and a miniature crane operable for fetching dolls, toys and/or other prizes located in the booth. The booth includes windows through which the dolls, toys and/or other prizes can be observed clearly. A frame is provided between any two adjacent ones of the windows. Such a frame is generally made of aluminum alloy by extrusion.

Referring to FIG. 5, a conventional frame includes an external arched plate 1, an internal arched plate 2 and connecting portions 3 that connects the external arched plate 2 with the internal arched plate 3. The external arched plate 1 includes two edges, and so does the internal arched plate 2. A slit 4 is defined between each of the edges of the external arched plate 1 and a related one of the internal arched plate 2. An edge of a window 5 and a batten 6 are fit in each of the slits 4. The appearance of the frame is however dull.

In another conventional frame, a groove is defined in the external arched plate 1. A light tube is inserted in the groove. The groove looks like a circle in a cross-sectional view taken in a plane in perpendicular to an axis thereof, and so does the lighting unit. The groove includes an opening. The width of the opening is smaller than a diameter of the light tube taken in the plane. Therefore, the light tube can only be inserted into and removed from the groove along the axis. Such insertion and removing is possible only after a roof is detached from the booth. It is however inconvenient for a person to replace a light tube with a new one.

The present invention is therefore intended to obviate or at least alleviate the problems encountered in prior art.

### SUMMARY OF INVENTION

It is the primary objective of the present invention to provide an apparatus for supporting and decorating a window of a game machine.

To achieve the foregoing objective, the apparatus includes a frame, a lamp and a lens assembly. The frame includes a middle slab formed between two lateral slabs. Each of the lateral slabs includes a window-receiving groove, a V-shaped groove and a lens-receiving groove. The depth of the window-receiving groove of each of the lateral slabs is at an angle from that of the window-receiving groove of the other lateral slab. The middle slab is in parallel to a plane in which valleys of the V-shaped grooves of the lateral slabs lie. The lamp includes illuminators supported on a board. The board includes two edges inserted in the V-shaped grooves. The lens assembly includes lenses each including at least two tongues each extending from a side and including a tip movably inserted in the lens-receiving groove of a related one of the lateral slabs.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings, where:

FIG. 1 is a perspective view of a game machine including windows and supporting/decorating units according to the preferred embodiment of the present invention;

FIG. 2 is a perspective view of one of the supporting/decorating units shown in FIG. 1;

FIG. 3 is an exploded view of the supporting/decorating unit shown in FIG. 2;

FIG. 4 is a perspective view of a lens of the supporting/decorating units shown in FIG. 3; and

FIG. 5 is a perspective view of a conventional frame for supporting windows of a game machine.

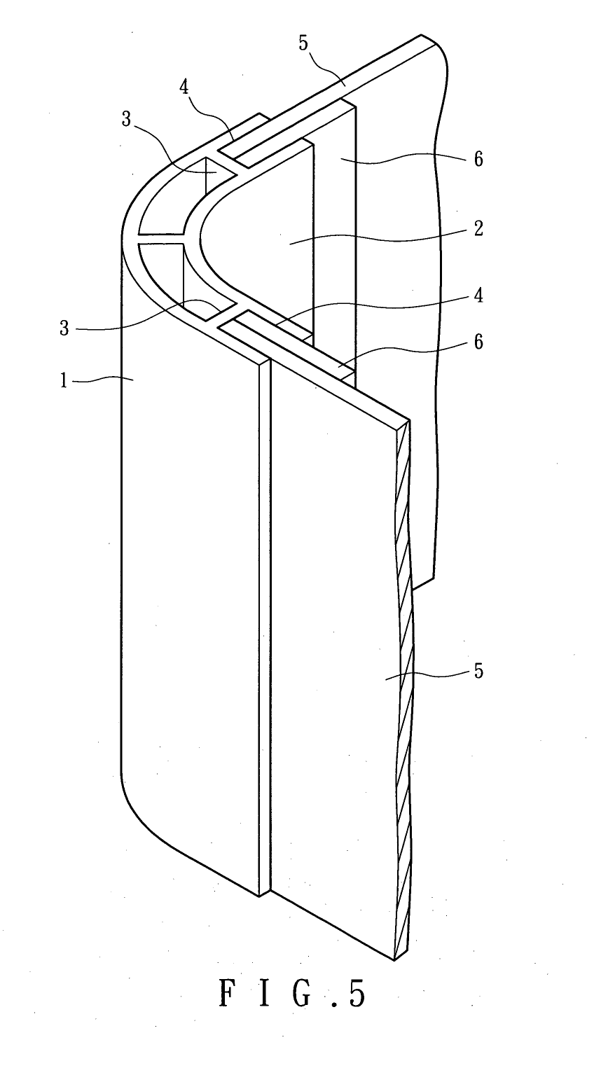

### DETAILED DESCRIPTION OF PREFERRED EMBODIMENT

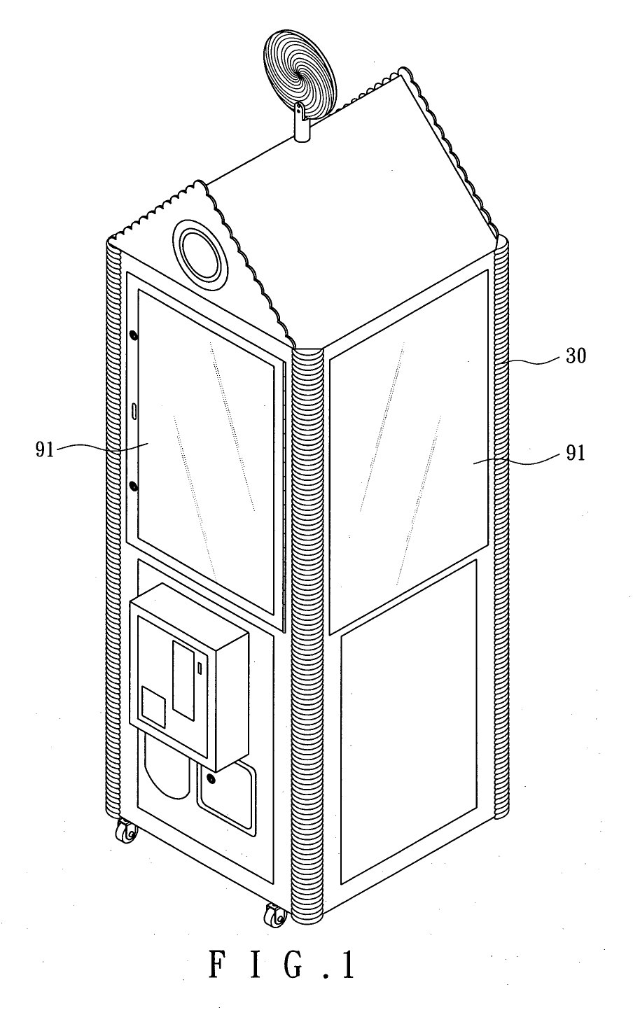

Referring to FIG. 1, a game machine including windows 91 supported with supporting/decorating units according to the preferred embodiment of the present invention. Any two adjacent ones of the windows 91 are interconnected by a related one of the supporting/decorating units.

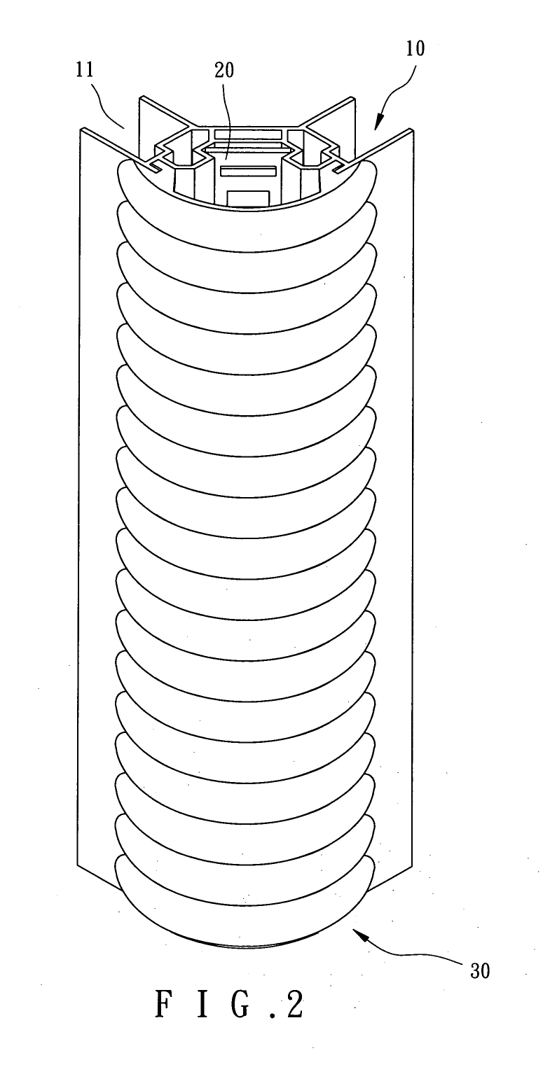

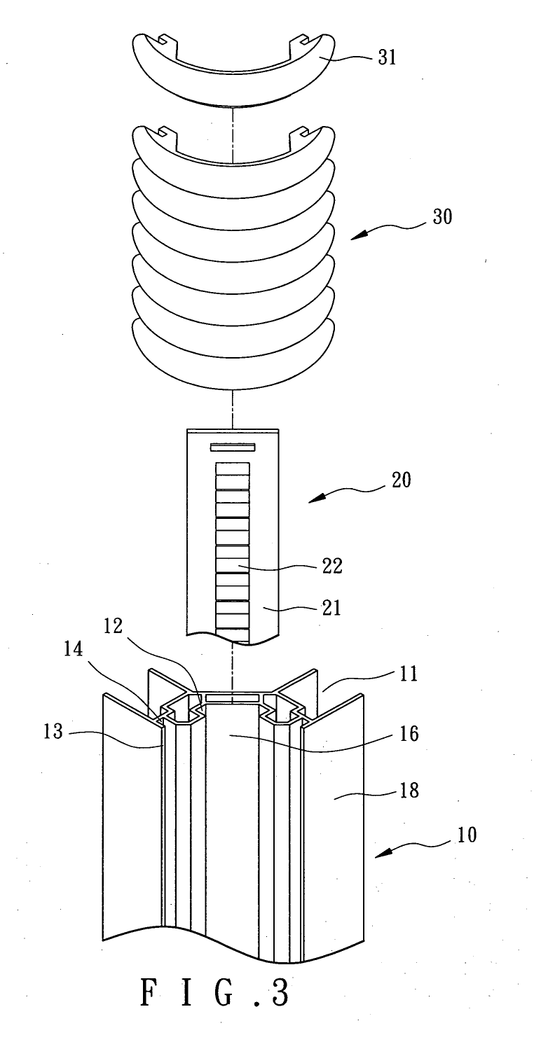

Referring to FIGS. 2 and 3, description will be given to only one of the supporting/decorating units for briefness. The supporting/decorating unit includes a frame 10, a lamp 20 provided on the frame 10 and a lens assembly 30 for protecting the lamp 20.

The frame 10 is made of aluminum alloy by extrusion. The frame 10 includes a middle slab 16 formed between two lateral slabs 18. The middle slab 16 is at 135 degrees from each of the lateral slabs 18. Each of the lateral slabs 18 is at the right angle from the other slab 18. A groove 11 is defined in the first edge of each of the lateral walls 18. The depth of each of the grooves 11 is at the right angle from the depth of the other groove 11. The thickness of the middle slab 16 is smaller than that of each of the lateral slabs 18 so that a portion of a second edge of each of the lateral slabs 18 is exposed. A V-shaped groove 12 is defined in the exposed portion of the second edge of each of the lateral slabs 18. Each of the V-shaped grooves 12 looks like a “V” when it is viewed along a length. Each of the V-shaped grooves 12 includes a valley, i.e., the deepest portion of the V-shaped groove 12. A plane in which the valleys of the V-shaped grooves 12 lie is in parallel to a front face of the middle slab 16. A groove 14 is defined in the second edge of each of the lateral slabs 18. In each of the lateral walls 18, the groove 14 is opposite to the groove 11. A rib 13 is formed on the second edge of each of the lateral slabs 18, next to the groove 14.

The lamp 20 includes a board 21 and illuminators 22 supported on the board 21. The board 21 is preferably a printed circuit board for mechanical support of and electrical connection to the illuminators 22. The board 21 is made with some elasticity. The illuminators 22 are preferably light-emitting diodes for low consumption of electricity and light weight. The board 21 can be used to control a sequence and/or timing to turn on the illuminators 22 to emit various colors of light.

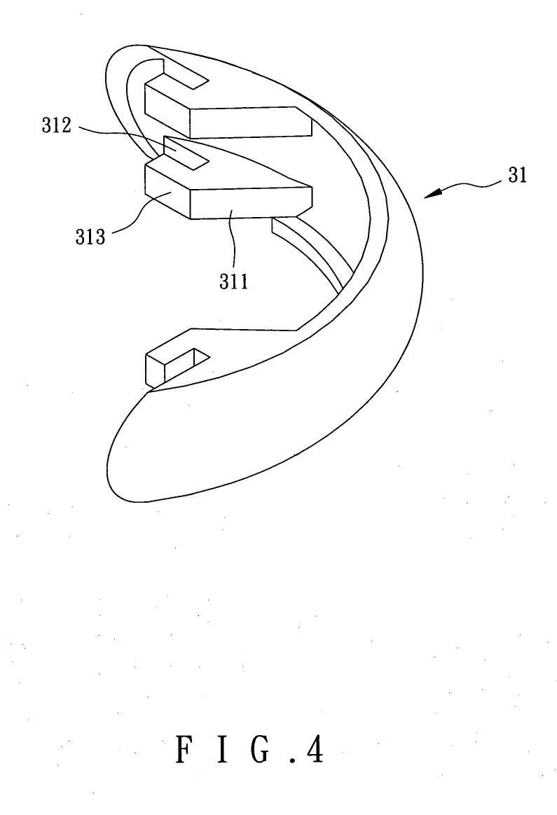

The lens assembly 30 includes lenses 31 that can be made of various colors. Referring to FIG. 4, description will be given to only one of the lenses 31 for briefness. The lens 31 is made of a translucent or transparent material such as glass or acryl resin. The lens 31 includes an arched configuration. An external side of the lens 31 is smooth. At least two tongues 311 are formed on an internal side of the lens 31, with each of the tongues 311 located near an end of the lens 31. Preferably, two pairs of tongues 311 are formed on the internal side of the lens 31, with each of the pairs located near a related one of the ends of the lens 31. Each of the tongues 311 includes a root extending from the internal side of the lens 31 and a tip 313 extending from the root. The tip 313 of the tongue 311 is spaced from the internal side of the lens 31 by a slit 312.

Referring to FIG. 1 again, each of the windows 91 is supported with two related ones of the supporting/decorating units. Each vertical edge of each of the windows 91 is inserted in the groove 11 of the first edge of a related one of the lateral slabs 18 of a related one of the frames 10.

Referring to FIGS. 2 and 3 again, the board 21 is located between the second ends of the lateral slabs 18, with each edge inserted in a related one of the V-shaped grooves 12. The edges of the board 21 can be inserted into the V-shaped grooves 12 along a length before a roof is provided on the supporting/decorating units during production of the game machine. However, because of the elasticity of the board 21 and the shapes of the V-shaped grooves 12, the edges of the board 21 can be inserted into or taken from the V-shaped grooves 12 in a direction in perpendicular to the length without having to detach the roof from the supporting/decorating units during maintenance of the game machine.

The lens assembly 30 is located between the second ends of the lateral slabs 18 to protect the lamp 20. The tongues 311 tongue the ribs 13, with the tips 313 of the tongues 311 inserted in the grooves 14. The tips 313 of the tongues 311 are inserted into the grooves 14 along the length. The slits 312 receive the ribs 13. It is preferred that each of the lenses 31 protects a related one of the illuminators 22.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for supporting and decorating a window, the apparatus comprising:
a frame (10) comprising:
two lateral slabs (18) each comprising:
a window-receiving groove (11) defined in a first edge, wherein the depth of the window-receiving groove (11) of each of the lateral slabs (18) is at an angle from that of the window-receiving groove (11) of the other lateral slab (18);
a V-shaped groove (12) defined in a second edge; and
a lens-receiving groove (14) defined in the second edge;
a middle slab (16) formed between the lateral slabs (18), wherein the middle slab (16) is in parallel to a plane in which valleys of the V-shaped grooves (12) of the lateral slabs (18) lie; and
a lamp (20) comprising illuminators (22) and a board (21) that supports the illuminators (22) and includes two edges inserted in the V-shaped grooves (12); and
a lens assembly (30) comprising lenses (31) each comprising at least two tongues (311) each extending from a side and comprising a tip (313) movably inserted in the lens-receiving groove (14) of a related one of the lateral slabs (18).

2. The apparatus according to claim 1, wherein the angle is the right angle.

3. The apparatus according to claim 1, wherein the board (21) is a printed circuit board, wherein the illuminators (22) are light-emitting diodes mechanically supported on and electrically connected to the printed circuit board.

4. The apparatus according to claim 1, wherein each of the illuminators (22) is protected with a related one of the lenses (31).
